(19) United States
(12) Patent Application Publication
(10) Pub. No.: US 2016/0042228 A1
(43) Pub. Date: Feb. 11, 2016

(54) SYSTEMS AND METHODS FOR RECOGNITION AND TRANSLATION OF GESTURES

(71) Applicant: MOTIONSAVVY, INC., Rochester, NY (US)

(72) Inventors: Alex Opalka, San Diego, CA (US); Wade Kellard, San Diego, CA (US)

(21) Appl. No.: 14/686,708

(22) Filed: Apr. 14, 2015

Related U.S. Application Data
(60) Provisional application No. 61/979,481, filed on Apr. 14, 2014.

(51) Int. Cl. G06K 9/00; G06F 17/30; G06K 9/62; G06F 3/01

(52) U.S. Cl. CPC G06K 9/00355; G06F 3/017; G06K 9/00389; G06F 17/30256; G06K 9/6202

(57) ABSTRACT

A system for recognizing hand gestures, comprising a gesture database configured to store information related to a plurality of gestures; a recognition controller configured to capture data related to a hand gesture being performed by a user; a recognition module configured to: determine hand characteristic information from the captured data, determine finger characteristic information from the captured data, compare the hand and finger characteristic information to the information stored in the database to determine a most likely gesture, and outputting the determined most likely gesture.

### BACKGROUND

1. Technical Field

The embodiments described herein are related to gesture recognition technologies and in particular the use of such technologies for sign language recognition and translation.

2. Related Art

People who use sign languages, such as American Sign Language (ASL) used in the United States, as their primary language communicate with people who do not sign and using technology in a variety of ways. For example, interpreters can be used as can video phone systems, instead of a telephone. Often, deaf people are fairly proficient at reading lips, so video conference can allow a deaf individual to not only communicate using sign language as well as comprehend what is being said on the other end. But these methods are not very efficient and do not allow for the deaf person to communicate in a personal and natural way.

In the past there have been many different kinds of sign language recognition systems that were utilized to detect signs. These systems are typically based upon the detection of 2D images and video that the software application can then process to determine the sign. The current recognition and images of words and sign language linguistics for ASL rely on cameras or accelerometers to create a database. Such databases show in depth videos analysis and motion analysis of individual words in sign language. The issue with such technologies, whether images or video files, is that current technology cannot properly contain enough detail to be accurate enough for real time detection of sign language.

### SUMMARY

Systems and methods for gesture recognition are described herein.

According to one aspect, a system for recognizing hand gestures, comprises a gesture database configured to store information related to a plurality of gestures; a recognition controller configured to capture data related to a hand gesture being performed by a user; a recognition module configured to: determine hand characteristic information from the captured data, determine finger characteristic information from the captured data, compare the hand and finger characteristic information to the information stored in the database to determine a most likely gesture, and outputting the determined most likely gesture.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIGS. 1A and B is a diagram illustrating an example a high accuracy and resolution motion controller;

FIG. 2 is a diagram illustrating an example hemispherical field, operating at 150° of view provided by the controller of figure;

FIG. 3 is a flow chart illustrating an example process for determining hand characteristics in accordance with one example embodiment;

FIG. 4 is a flow chart illustrating an example process 400 for determining finger characteristics in accordance with one example embodiment;

FIG. 5 is a diagram illustrating hand and finger positions for numbers 1-9 in ASL;

FIG. 6 is a block diagram illustrating detection of these ASL numbers in accordance with one example embodiment;

FIG. 7 is a diagram illustrating the letters A-Z in ASL;

FIG. 8 is a flow chart illustrating letter recognition in accordance with one example embodiment;

FIG. 9 is a flow chart illustrating an example process for determining a sign in accordance with one embodiment;

FIG. 10A illustrates a registration screen that allows the user to create a user profile;

FIG. 10B illustrates and example screen that can be shown to a user in order to initiate a training process that will help the system to begin to account for user specific signing habits or characteristics

FIG. 11 is a flow chart illustrating and example process to collect information from each user profile in accordance with one example embodiment;

FIG. 12 is a table of example classifiers used to simplify the recognition process in accordance with one embodiment;

FIG. 13 is a table providing the main features of sign language;

FIG. 14 is a flow chart illustrating an example decision tree process in accordance with one example embodiment;

FIG. 15 is a diagram illustrating an example sign;

FIG. 16 is a flow chart illustrating an example process for adding signs into a database in accordance with one example embodiment;

FIG. 17 illustrates example entries for a user profile entry and a sign entry in a database in accordance with one embodiment;

FIG. 18 is a diagram illustrating voice recognition included in the systems and methods described herein in accordance with one embodiment;

FIG. 19 is a diagram illustrating how text can be outputted to an animated avatar that “speaks” the text in sign language in accordance with one embodiment;

FIG. 20 is a diagram illustrating that the systems and methods described herein can be configured to recognize text and convert it to a predetermined voice;

FIG. 21 is a diagram illustrating that the systems and methods described herein can be configured to recognize signs and then convert them to text or voice, using a text-to-speech module or engine;

FIG. 22 is a diagram illustrating the use of using facial recognition software in accordance with one example embodiment;

FIG. 23 is a table illustrating various countries and the relevant sign languages;

FIG. 24 is a flow chart illustrating a more detailed training process in accordance with one example embodiment;

FIG. 25 is a flow chart illustrating an example training process for a computer interface application in accordance with one embodiment;

FIG. 26 is diagram illustrating gesture recognition in accordance with one example embodiment.

FIG. 27 is a flow chart illustrating an example process for training and using a web based system in accordance with one embodiment;

FIG. 28 is a diagram illustrating interaction with their web-based translation platform in accordance with one embodiment;

FIG. 29 is a block diagram illustrating a mobile implementation of the systems and methods described herein in accordance with one example embodiment;

FIG. 30 is a diagram illustrating a two-way communication system configured in accordance with one example embodiment;

FIG. 31 is a table listing hardware and materials for use with the Tablet-Style Operating System in accordance with one example embodiment;

FIG. 32 is a table listing hardware and materials for use with the Smartphone-Style Operating System in accordance with one embodiment;

FIG. 33 is a diagram illustrating an example tablet configured in accordance with one embodiment;

FIG. 34 is a diagram illustrating an example smart phone configured in accordance with one embodiment;

FIG. 35 is a diagram illustrating a standalone device configured in accordance with one embodiment;

FIG. 36 is a table listing hardware and materials for use with the video phone system in accordance with one embodiment;

FIG. 37 is a diagram illustrating and video phone systems configured in accordance with one embodiment;

FIG. 38 are screen shots for common examples of how ASL can be taught using the systems and methods described herein;

FIG. 39 is table of hardware components that can be used to implement an educational system in accordance with one example embodiment

FIG. 40 is a diagram of an example educational system in accordance with one example embodiment; and

FIG. 41 is a block diagram illustrating an example wired or wireless system that can be used in connection with various embodiments described herein.

### DETAILED DESCRIPTION

In the embodiments described herein, systems and methods for sign language recognition are presented. It will be understood that the embodiments described are by way of example only and that not necessarily all components, sub-parts, sub-systems, steps, etc. are disclosed. Further, while many of the embodiments below are described with respect to American Sign Language (ASL), it will be apparent that the systems and methods can also be used for recognition of other sign languages such as Signed Exact English (SEE) and English Sign Language (ESL). Thus, the systems and methods described herein are more generally directed to sign language recognition and translation, and even more generally to gesture recognition.

Efficient recognition of ASL to improve communication has been explored for many years. Previous research has been conducted with devices like the Microsoft Xbox Kinect system which uses a bi-ocular camera system for detection of signed gesture in a frame by frame analysis of position vs. time. However, most applications that geared toward sign recognition capture information with very low accuracy.

Newer motion sensing devices like the LEAP Motion Controller, can be possible to track and detect sign language in 3D space, using algorithms to track the users signed gestures in a data point cloud. With these algorithms implemented in the LEAP Software Development Kit (SDK), in accordance with the embodiments describe herein includes, a platform where certain mathematical models and algorithms can be used to correctly determine the various letters, numbers, or phrases that an ASL user can use to communicate.

A sign language database can then be developed that uses motion sensing to create extremely accurate representations of each word in ASL. The embodiments herewith allow users to sign each gesture, which can be run through a Sign Language Database to determine if it is a word, letter, or number in ASL. The software that can detect the hand shapes and movements of signs in ASL. The algorithms explained can be implemented utilizing the LEAP SDK, which is a powerful API for developers to use when writing software applications that use the LEAP Motion Controller. This API is freely available to the public, and the algorithms were designed with this API in mind. The many applications that this sign language database can be used for are also described.

As noted above, conventional systems and approaches for sign language recognition are unable to capture enough information to allow for consistent and accurate recognition. The systems and methods described herein use newer motion sensing technology, e.g., motion sensing technology like the LEAP Motion Controller. When such motion sensing technology is used along with a sign language database as described herein, real-time recognition of signs is made possible.

A controller such as the LEAP controller uses as described herewith algorithms that determine the edges of the hand and then calculates the surface area based on cross sectional slices. A three dimensional and mathematical modeling, e.g., LEAP SDK, of the hand allows structuring and recognition of the input data components of signed gesture. Such a controller, when used in conjunction with the sign language database is then capable of successively detecting specific sign characteristics within 3D space with little to no error.

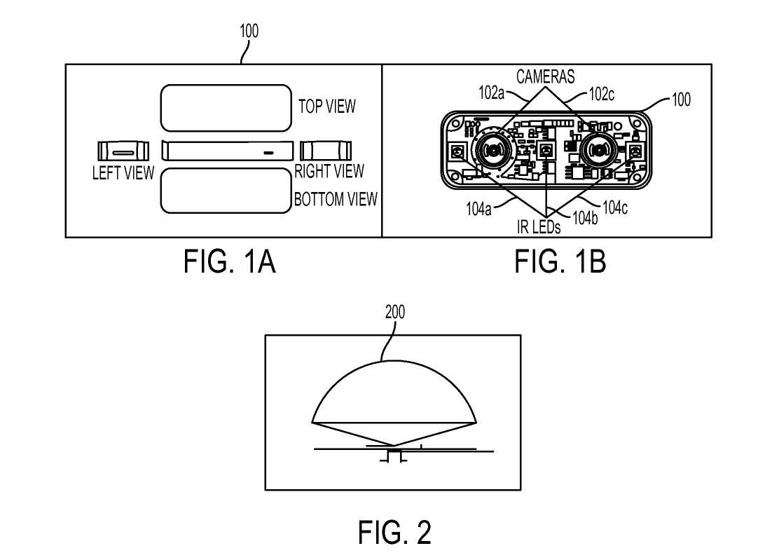

Thus, in certain embodiments, a high accuracy and resolution motion controller, such as the one illustrated in FIG. 1, can be used to sense the motion of the individual's hands. FIG. 1A illustrates a top, bottom, left and right view of the controller 100. As can be seen, the controller 100 is compact and low profile. As illustrated in FIG. 1B, the motion controller 100 can comprise two cameras 102a and 102b and three infrared light emitting diodes 104a, 104b, and 104c configured to capture images at up to, e.g., 200 Frames Per Second (FPS). This gives controller 100 the ability to detect even the slightest movements that the user makes in a cloud of data. When using a controller, such as controller 100, the user is interacting in an 8 cubic feet 3D field originating from a height of 2 centimeters above the unit. The field 200 is illustrated in FIG. 2. The field 200 essentially provides a hemispherical, operating at 150° of view.

In certain embodiments, the controller 100 should be placed somewhere in front of (and parallel to) a display (not shown) in a place chosen by the user. Ideally, the controller 100 can operate above 15-50 FPS. Using specific mathematical models and algorithms described herein, along with, e.g., the LEAP SDK, it is possible collect movement and handshape data to determine an expected output. The controller 100 hardware should be design specifically for 3D gesture recognition, which is ideal for, e.g., ASL, which is a gestural-based language. Algorithms that take characteristics of a predetermined data-set, at a specified frame-rate, such as those described herein, can then be used with, e.g., the LEAP SDK to drive recognition.

Certain algorithms can also be used that will detect and take into account changes in the position of the controller 100, such as rotation of the controller 100. Such changes will often change the recognition capabilities for the controller 100; however, because the algorithms take the change of position into account, the user does not need to be concerned about controller placement.

Once a gesture is captured, gesture data is transferred to a recognition module to accurately detect hands and fingers, which is necessary for the systems and methods described herein to be fully functional. First, the recognition module can make some determinations about the user's hands. For example, the system can determine what hand the individual is signing with, how many hands are being used, features of the palm, etc.

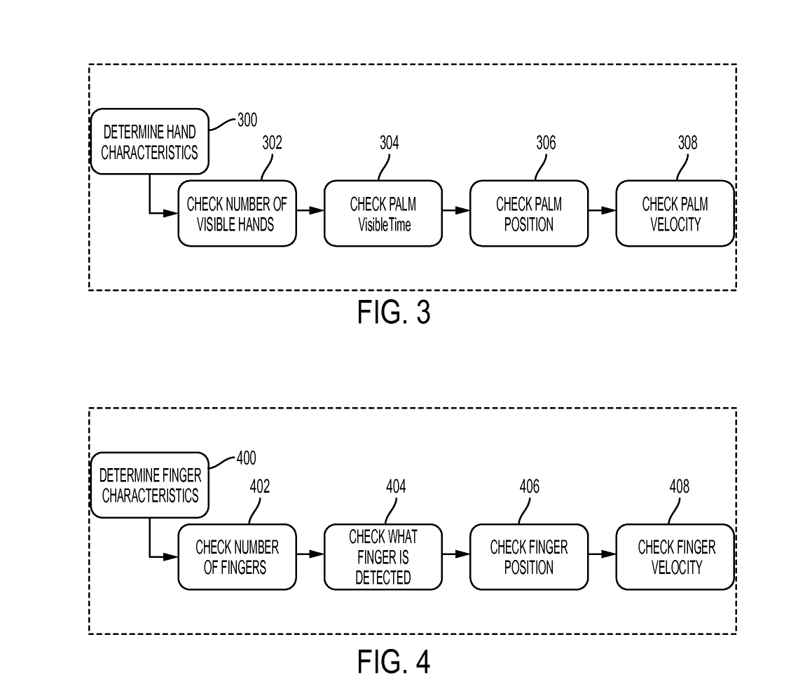

FIG. 3 is a flow chart illustrating an example process 300 for determining hand characteristics in accordance with one example embodiment. First, in step 302, the recognition module can be configured to determine the number of visible hands. Then in step 304, the recognition module can determine a palm visible time and, in step 306, the palm position can be determined. In step 308, a palm velocity can be determined.

The recognition module can also be configured to make some determinations about the users fingers. FIG. 4 is a flow chart illustrating an example process 400 for determining finger characteristics in accordance with one example embodiment. First, in step 402, the recognition module can be configured to check the number of fingers and, in step 404, what finger is being used. In step 406, the finger position can be determined and in step 408 the finger velocity can be determined.

The processes of FIGS. 3 and 4 can be necessary in order to accurately determine hand characteristics needed to have efficient recognition of sign language. Moreover, in certain embodiments, controller 100 can also be configured to accurately track user's forearms and, e.g., recognition module can be configured to represent the orientation in comparison to their hands. It should also be noted that even for standard signs that do not, for example, require information about emotion or body language, an individual can still sign them with minute differences. Thus, the recognition module should be able to make some determinations about the user as they sign various letters.

Accordingly, the system can be configured to store information related to basic retrained handshapes or profiles of hand shapes trained by the user, e.g., upon registration of the system. This data allows the user to modify the signing detection algorithms to their specific manner. This allows for a level of personalization that is nonexistent in conventional systems.

In ASL, there is little to no complex classifiers that are needed for detection. As such, the systems and methods described herein can be easily applied to number recognition. As noted, other signs can require information about body features such as emotion and body language. But numbers do not need more than the basic classifiers or handshapes that represent them, along with user specific information as noted above.

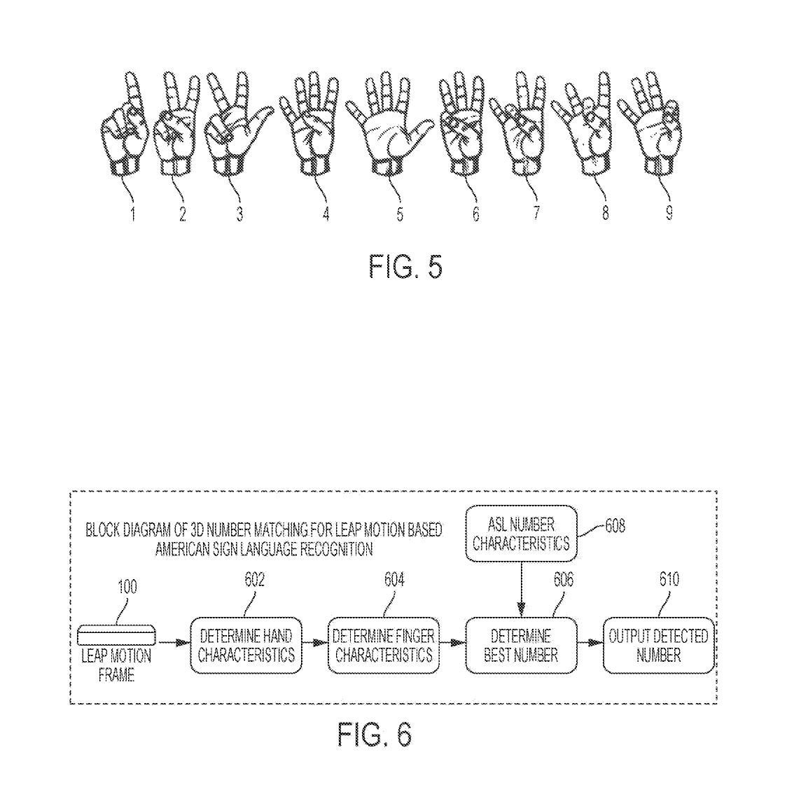

FIG. 5 shows the hand and finger positions for numbers 1-9 in ASL. FIG. 6 is a block diagram illustrating detection of these ASL numbers in accordance with one example embodiment. First, the data from controller 100 is received and then hand characteristics can be determined in step 602. For example, the process of FIG. 3 can be used to determine hand characteristics in step 602. Next, in step 604, finger characteristics can be determined, e.g., as described with respect to FIG. 4. Again, the recognition can be modified or augmented by training data. ASL number characteristics can be obtained in step 608 and used in conjunction with the determined hand and finger characteristics to determine the best number fit. The determined number can then be output in step 610. The determined number can then be output, e.g., as text or voice.

The system should determine if the number that is detected is correct based upon a number of different variables it gathers and then match against known characteristics of each number in ASL.

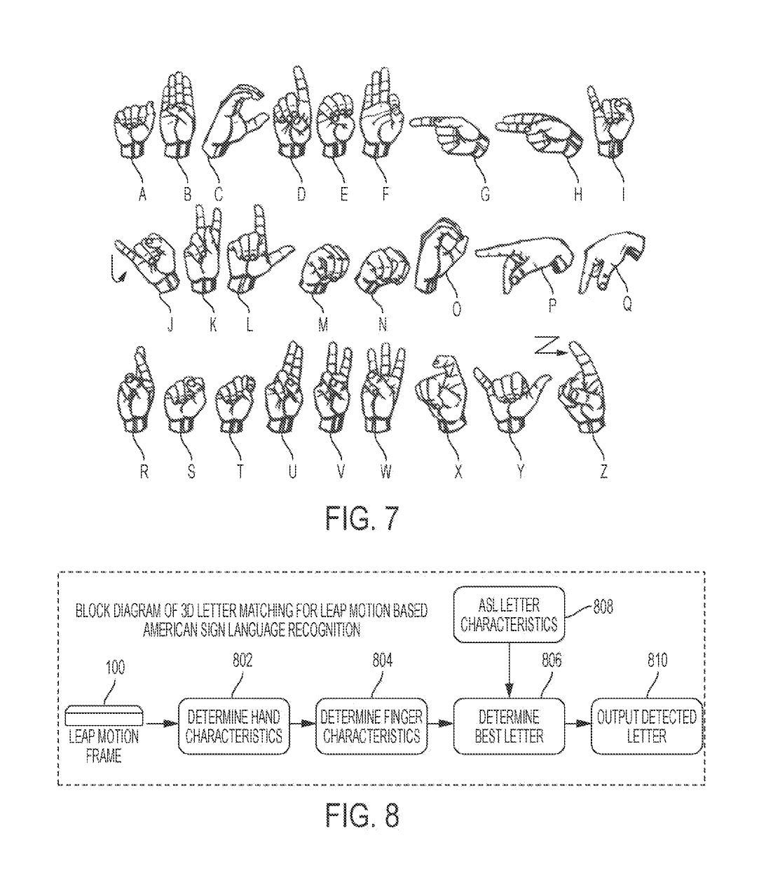

A similar process can be used to detect letters. FIG. 7 illustrates the letters A-Z in ASL. Again, while these signs are standard, somebody could sign them with different styles. Thus, the system should be able to detect or learn these different styles as noted above. The system should be able to make some determinations about the users hand and finger characteristics. The system should be able to determine if the letter that is detected is correct based upon a number of different variables it gathers and then match against known characteristics of each letter in ASL. This data can then be utilized in a text or voice format and be outputted as such.

FIG. 8 is a flow chart illustrating letter recognition in accordance with one example embodiment. First, in step 802, recognition information can be received from controller 100 and hand characteristics determined. Then is step 804 finger characteristics can be determined. In step 808, ASL letter characteristic information stored in the system can be used in combination with the hand and finger characteristic information determined in steps 802 and 804 to determine the best letter fit. The detected letter can then be output in step 810.

The system should be able to accurately detect signed phrases and words in, e.g., ASL to be fully functional. While these signs are standard, somebody could sign them with different styles as mentioned above. When using ASL, for example, emotion and context are important as well. A user who signs with a specific emotion, such as happy, sad, or angry, should be taken into account to determine the proper word to correspond with the sign. Context should also be analyzed to determine best word fit.

The process of determining a sign can comprise several steps. First, the system can determine if a classifier that is detected in the image data based upon a number of different factors, which are then matched against known characteristics of each classifier in ASL. The system can determine if the sign that is detected is correct based upon a number of different variables it gathers and then matches against known characteristics of each sign in ASL. This data can then be utilized in a text or voice format and be outputted as such. The basic output of the main block diagram output is the determined sign if the user is currently signing.

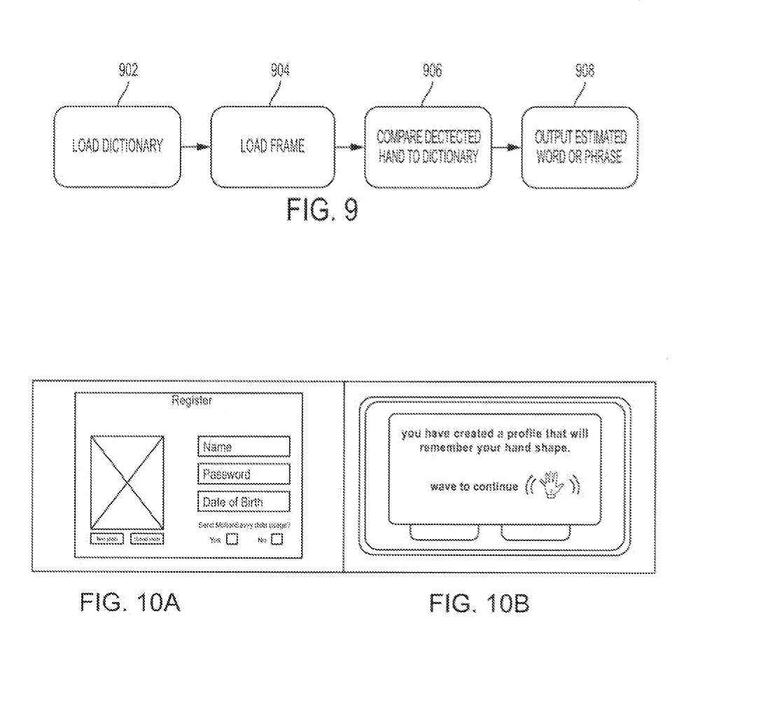

FIG. 9 is a flow chart illustrating an example process for determining a sign in accordance with one embodiment. First in step 902, a dictionary of signs can be loaded. Then in step 904, the controller 100 can detect a handshape and the relevant finger position and this information can stored as a frame. These frames contain the output data of the algorithms that the recognition module uses to determine if a specific sign is detected. The frame can then be compared with the dictionary entries in step 906 in order to determine the correct sign, which can be output in step 908.

Due to the fact that, e.g., ASL is a different language than spoken English, with many different “accents” or personalized styles. Different hand characteristics can best be described as habitual styles correlated to each person. It is also possible that physical limitations can impact a person's ability to sign, such as people with missing limbs, or those that have arthritis. The recognition system should be able to make sure that the user does not have to adjust their signing style when using the system.

In order to account for this, data can be formulated into a user profile that is then used by the system during the recognition process. The system can also account for user's gender and hand sizes during the initialization process. These user profiles store the data locally or off site and can be used take into account various things such as finger lengths and widths and habitual signing styles. This is implemented in a user friendly way so that the user does not have to go through lengthy and unwanted training processes. FIG. 10A illustrates an registration screen that allows the user to create a user profile. FIG. 10B illustrates and example screen that can be shown to a user in order to initiate a training process that will help the system to begin to account for user specific signing habits or characteristics.

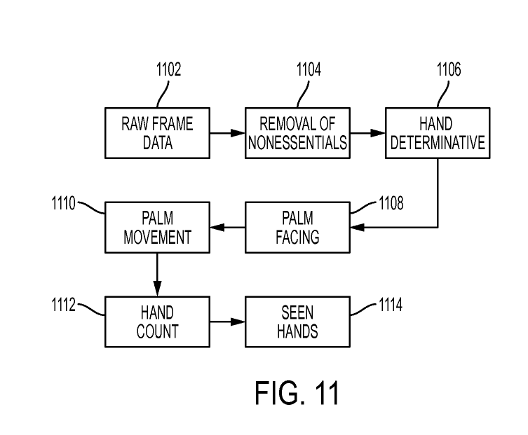

Further, in order to improve accuracy over time, recorded data can be collected for each sign and stored into a database. The more users repeat a sign as they use the system, the higher accuracy and efficiency the system can provide. This is made possible by specific algorithms for machine learning processes that remember specific habitual styles and improve accuracy over time. For example, the example process illustrated in FIG. 11 can be used to collect information from each user profiles. This process can also be used in different regions so that signs that may not be readily documented can be added to the system over time.

As can be seen, the process of FIG. 11 begins with the acquisition of raw frame data from controller 100. In step 1104, non-essential information included in the raw frame data are removed. In step 1106, the hand position is determined and in step 1108 a determination is made as to which direction the palm is facing. In step 1110, palm movement is detected. In step 1112 a determination is made as to whether are multiple hands, i.e., the number of seen hands. In step 114, the identified hands are processed.

The system should be designed with efficiency in mind. There can be constant improvements in the algorithms over time to help differentiate between different signs in order to improve accuracy. This can be done by generating comparisons of signed gestures in real-time in order to better determine the correct sign and the word or phrase associated with it.

A sign builder module allows the user to add signs to the dictionary of signs that is stored in the database. Key features stored with respect to each sign in the dictionary can include the selection of number of hands the sign uses, the selection of classifiers, hand movement selection, and palm orientation. When a user is adding signs to the dictionary, these features can be stored locally and then uploaded to the database. The user can then record the sign using controller 100. The updated dictionary can be provided to complete network of devices.

The system can have access to a stored dictionary of words which have a root difference column in the database of data. This root difference can be used to determine a sign attempting to be finger spelled and submit the full word. This enables for the user to quickly fingerspell whole words within 2-5 letters. This is very desirable for longer words that would otherwise have to be finger spelled fully, saving time and effort by our users.

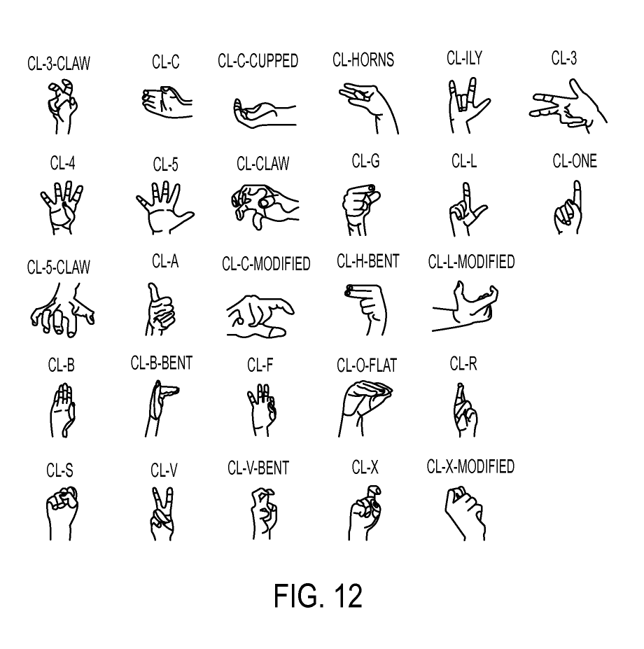

Matching classifiers to words and phrases in, e.g., ASL can be a key function for accurate sign determination. Handshapes are one of the five fundamental building blocks or parameters of a sign. The five building blocks are: hands shape, movement, location, orientation, and non-manual markers. Non-manual markers include the aspects of body language that do not involve the hands such as shoulder movements, head tilts, facial expression, etc. The commonly recognized handshapes that make up, e.g., ASL are divided up into “classifiers”. Classifiers can be used to simplify the recognition process. Example classifiers are illustrated in FIG. 12.

The movement and placement of a classifier handshape can convey information about the movement, type, size, shape, location or extent of the thing being referred to, or referent. A referent is that which you are talking about or that to which you are referring.

Due to the fact that the controller can use a data point cloud to retrieve large amounts of input data in every frame, determining what data to use for, e.g., ASL recognition can be very complex. Extracting features of that data can reduce the large amount of data to small amounts of data, enabling effective processing and optimized performance. Transforming the input data into the set of features is called feature extraction, which is a unique method of dimensionality reduction. When defining specific attributes of a signed gesture, input data has to be transformed into a reduced data set of features unique to that specific signed gesture. The features that are extracted are chosen in the broadest sense with the expectation that a set of features can contain the relevant information to accurately recognize a sign.

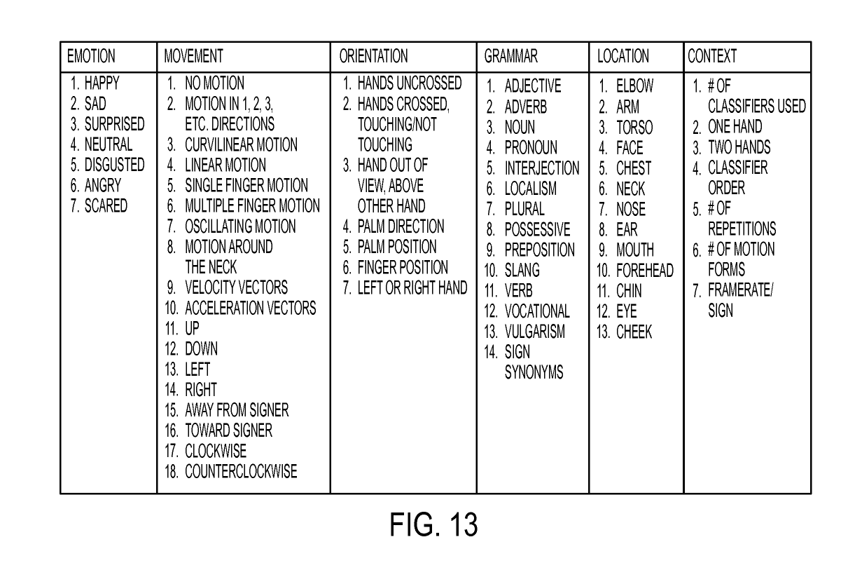

The table of FIG. 13 provides the main features of sign language. This information is defined as the feature extraction of input data in order to output the desired sign by using a reduced representation of a full size input. Appendix A includes a more complete list of features.

When performing analysis of the complex input data of sign language, there are a large number of variables involved. The analysis of the large number of variable can be put into a decision tree process which allows accurate determination of a signed gesture.

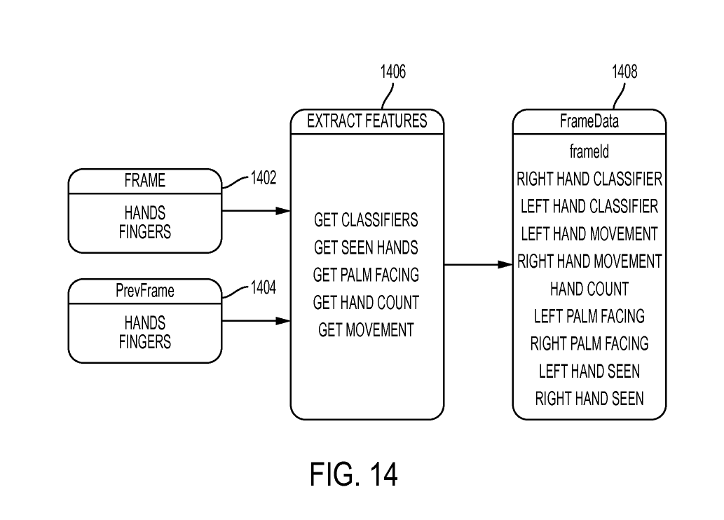

The flow chart of FIG. 14 illustrates an example decision tree process in accordance with one example embodiment, along with some example features of signs. As can be seen, in steps 1402 and 1404, information relates to hands and fingers are obtained from the current frame as well as the prior frame. Features are then extracted from the data. These features can include classifiers, seen hands, palm facing information, hand count, and movement. Frame data can then be extracted in step 1408. This frame data can include frame ID, left hand classifier, right hand classifier, left hand movement, right hand movement, hand count, left palm facing, right palm facing, left hand seen, right hand see, etc. The frame data extracted would then start to narrow the number of variables and suggest the next set of variables to extract.

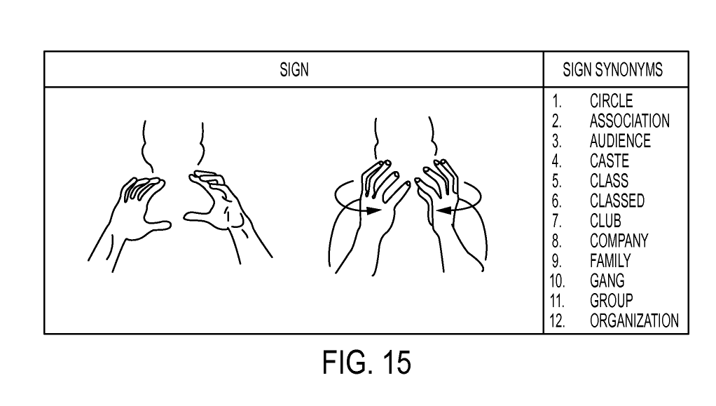

Signed gestures can mean many different words, so it is important to be able to select the appropriate word to correspond with a sign. Sign synonyms are glosses of English words for which the same sign is used. For example, in FIG. 15 we see a sign that is composed of two hands that are each in the CL-C shape that start with palms facing away from the chest and are then swung around in unison so that the palms end up facing the body. This sign symbolizes “a grouping together,” and can be used with several sign synonyms.

It is important to remember that the cross-referenced words do not always carry an equivalent sense of meaning. This is because meaning for the signer springs from the context of the signs used. It is also important to note that apparently unrelated glosses can be expressed by similar movements. Accordingly, as noted above, context can be analyzed using a language processing engine to help determine best word fit.

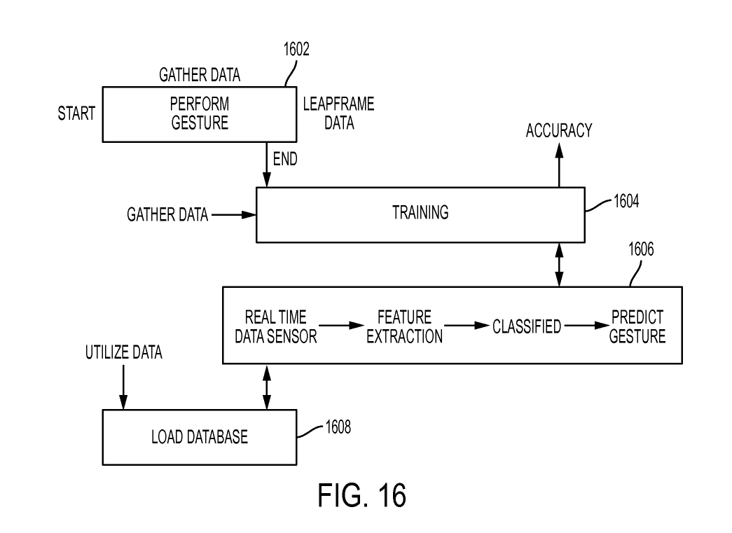

Thus, the recognition module and language processing engine can work with the data provided by the controller 100 to determine best fit for numbers, letters, word and signs by comparison to the data stored in the sign language database. As noted above, signs can be added into a database in order to create a robust dictionary that can be used to recognize and interpret signs. The example process can be seen in FIG. 16. The algorithm for matching signs can contain two different components, the first being that the software gathers crucial data (steps 1604 and 1606) from the frame data for detection, the second being the comparison against, e.g., ASL characteristics (step 1606). Once the system is trained and can recognize the sign, then the sign can be loaded into the database in step 1608.

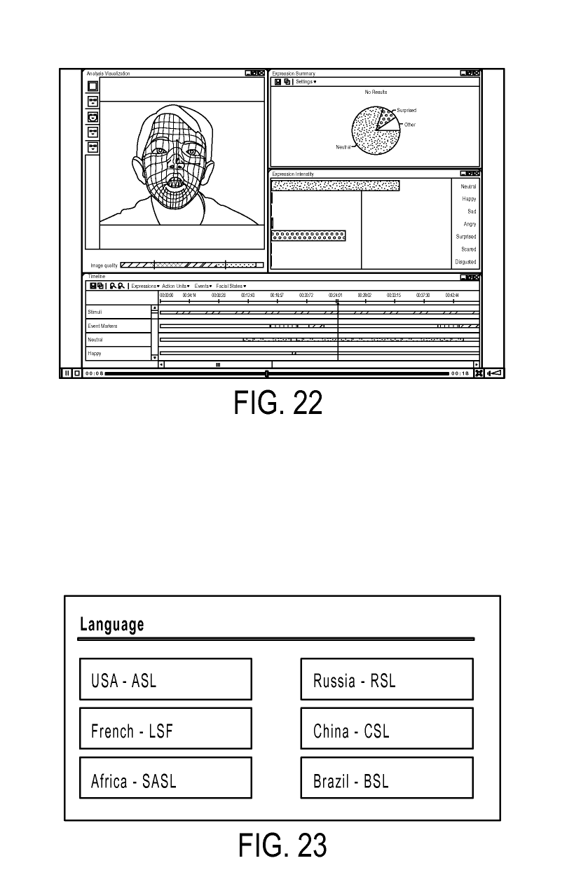

The sensor data that can be gathered in step 1606 can include data that allows the system to recognize and determine the emotions of a deaf/hard-of-hearing person so as to fully convey what is being said. A user who signs with a specific emotion, such as happy, sad, or angry, can be taken into account to determine the proper word to correspond with the sign. This can be accomplished by using facial recognition software such as the Noldus Face ReaderX, as seen in FIG. 22.

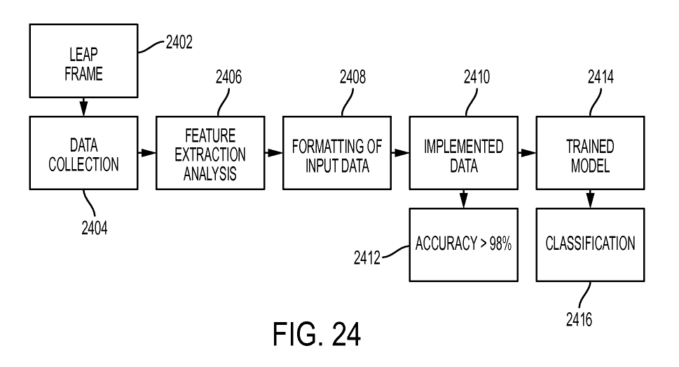

The training of step 1604 can comprise four basic steps including gathering data, analyzing data, formatting data, and implementation of the data. FIG. 24 is a flow chart illustrating a more detailed training process that breaks these four basic steps up into a few more steps, in accordance with one example embodiment.

Gathering data can comprise gathering data (step 2404) included in captured frames (step 2402) from signs repeated a specific number of times. The trainer module can select specific features (step 2406) about the sign and assign sign synonyms to the sign itself. There can be two different types of training data; static postures and temporal gestures. A static posture, for example, could be a user making a sign that doesn't move, in a certain orientation. Alternatively, a temporal gesture could be a user making a left-handed swipe gesture in front of the interface. Temporal gestures can be defined as a cohesive sequence of movements that occur over a variable time period.

The system can then analyze the data points and begin to assign feature associations to a specific gesture. This process can be broken down using two methods; Dynamic Time Warping (DTW) is a powerful classifier method that is used for recognizing temporal gestures, Support Vector Machine (SVM) is a powerful classifier method that works well on a wide range of classification problems.

After recording and analyzing the training data the system can then format the data (step 2408) to be used to train the classification or algorithm. After training the pipeline the system can quickly test (step 2412) it to validate how well the pipeline can work with new data. The data can then be structured into local and cloud based file storage that can be used for the implementation process (steps 2410-2416).

After training, the system can then use the new information to predict the class label (i.e. gesture label). The data can then be implemented into a sign language database.

The sign language database should be structured efficiently to enable smooth recognition of signed gestures. The database construction can begin by taking all the data from the controller based on the feature characteristics. The data can be analyzed and converted to a usable format.

The system can first gather important information that is used for the comparison portion of the algorithm. For example, the system can gather predetermined information as recognized by the system, if the user is currently signing. This information can then be matched up with certain features and categorized into specific data sets.

The system can take the information gathered and use the data in such a way that it can compare with given, e.g., ASL features. The system first attempts to determine obvious characteristics such as number of fingers, hand detected (right versus left), palm position, movement, and so on. The system can then output the estimated sign that is currently being recognized. Once this process is complete, data can then be utilized in a text or voice format and be outputted as such.

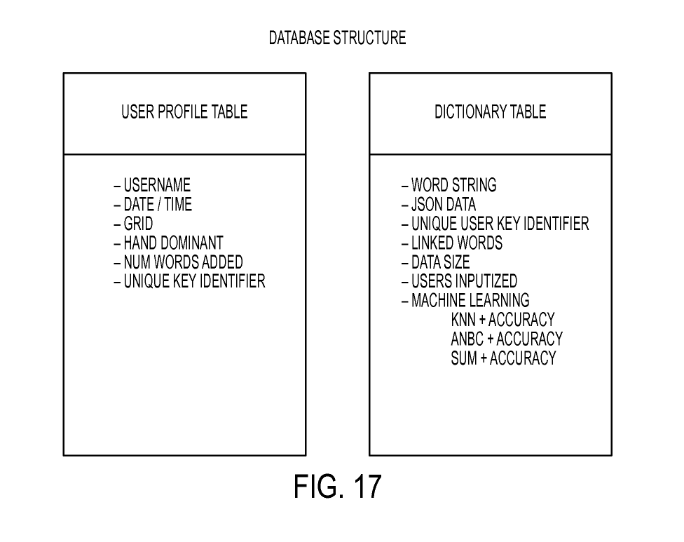

The database can store the dictionary as well as the user profiles described above. FIG. 17 illustrates example entries for both tables.

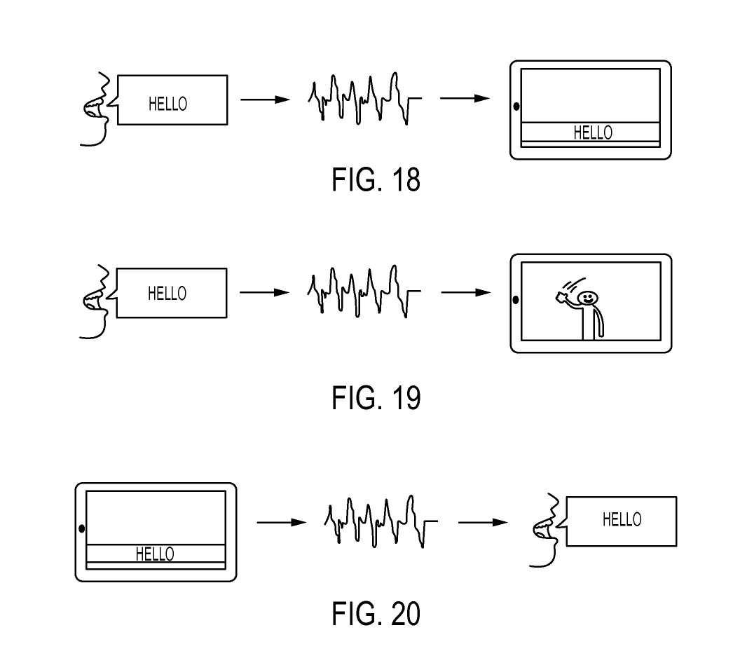

The system can also comprise a voice recognition module or engine configured to recognize voice and convert it to text, as illustrated in FIG. 18. In some cases that text can be outputted to an animated avatar that “speaks” the text in sign language, as seen in FIG. 19.

In certain embodiments, the system can also be configured to recognize text and convert it to a predetermined voice, as seen in FIG. 20.

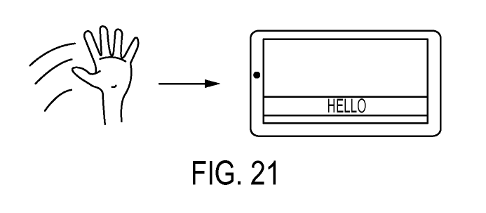

In certain embodiments, the system can be configured to recognize signs and then convert them to text or voice, using a text-to-speech module or engine. This is illustrated in FIG. 21.

There are many different kinds of sign language used around the world. These languages can also be put into the SLD. Users can select languages when using the system. Example of other languages are; French Sign Language (LSF), British Sign Language (BSL), and South African Sign Language (SASL). FIG. 23 is a table illustrating various countries and the relevant sign languages. Converting to other languages can be another function as well. Once text format is achieved, sentences can be converted to any language using language translation software.

The systems and methods described above can be used to enable numerous applications and devices to perform sign language recognition and translation. For example, the systems and methods described herein can be used to allow a user to interact with a computer. In certain embodiments, Basic Gestural Language (BGL) can be used for computer interaction when a controller 100, such as the LEAP controller is interfaced with the computer and using the database described above as a foundation. Conventional computer interaction methods involve using a mouse, keyboard, or voice input to achieve a desired action. But with the use of the Sign Language Database, it is possible to interact with a computer using signs.

In certain embodiments, users can assign specific signed gestures to a command and allow for more efficient computer navigation. For example, in FIG. 26 it can be seen that a user makes the sign for email, then the computer can translate that to a text input, then the computer can automatically recognize that text command and open up the users email. The systems and methods described herein should make interacting with a computer a natural and hands-free experience. Using the Sign Language Database, it is easy to program a computer to recognize specific gestures, such as illustrated in FIG. 26, to reach a desired output.

The systems and methods described above can be implemented as a software package that can be installed on a computer. Users can run the software and pick specific signs and assign them to a task. Ideally, when the software is running, all a user has to do is make a signed gesture, and then when the computer recognizes the gesture, the desired action can be initialized.

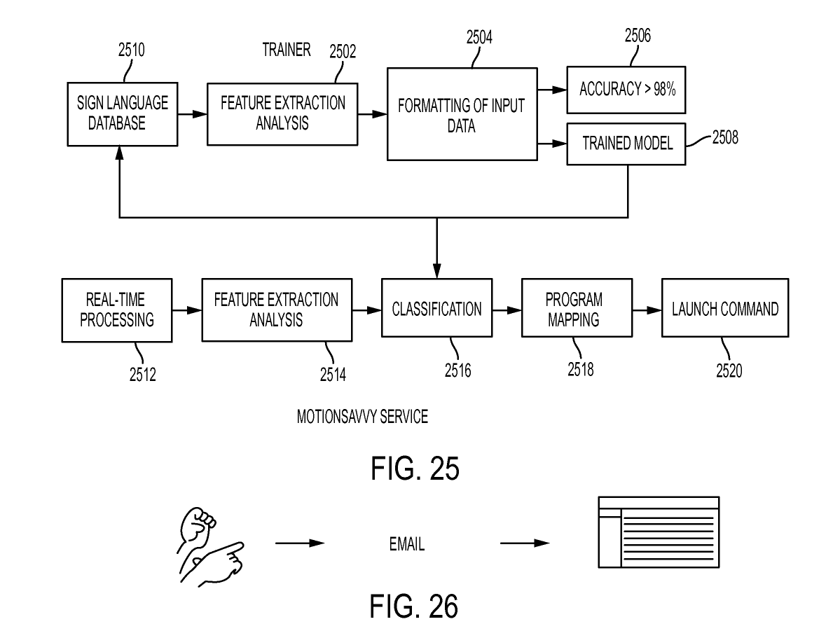

An example training process for a computer interface application is illustrated in FIG. 25. The training process is illustrated on the top half of the flow chart of FIG. 25, while the actual use of the software to control a computer is illustrated on the bottom. In order to train the software, the user selects a command and then performs a sign or gesture, preferably multiple times. Features are extracted (step 2502) by the system and formatted (step 2504) as described above. The system can then check to ensure a high level of accuracy (step 2506) and when the accuracy is achieved, the system is trained (step 2508) and the sign or gesture is stored in the database in step 2510.

Once the system is trained and the sign or gesture is in the database, the user can control a computer using a controller 100 interfaced with the computer. First, in step 2512, the user would make gestures, which would be captured and processed in real-time. Features would then be extracted in step 2514 and classification would occur in step 2516. After the gesture is identified, then it would be mapped to eh corresponding command in step 2518 and the command launched in step 2520.

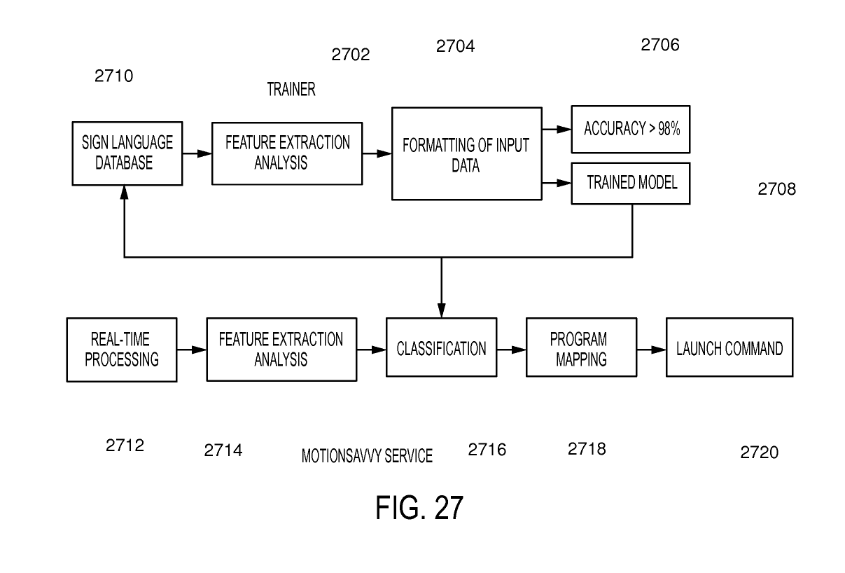

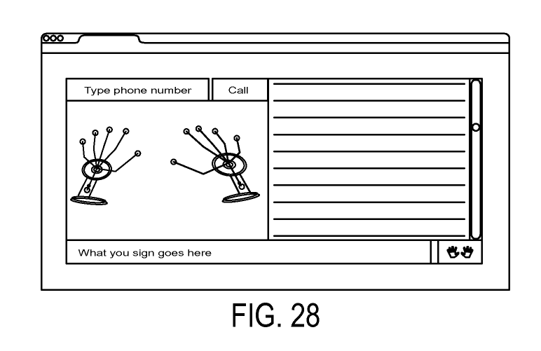

In certain embodiments, web browsers can be configured to run and operate the sign language database. Users can then use their personal computers as communication devices by simply opening up a webpage and using a controller 100 attached to their computer as described above. For example, using javascript and other web-based platforms, sign language translation can be used with any computer. In FIG. 27, we see process for training and using a web based system.

The training process is illustrated on the top half of the flow chart of FIG. 27, while the actual use of the software to control a web based implementation is illustrated on the bottom. In order to train the software, the user selects a command and then performs a sign or gesture, preferably multiple times. Features are extracted (step 2702) by the system and formatted (step 2704) as described above. The system can then check to ensure a high level of accuracy (step 2706) and when the accuracy is achieved, the system is trained (step 2708) and the sign or gesture is stored in the database in step 2710.

Once the system is trained and the sign or gesture is in the database, the user can control a web based application using a controller 100 interfaced with the computer. First, in step 2712, the user would make gestures, which would be captured and processed in real-time. Features would then be extracted in step 2714 and classification would occur in step 2716. After the gesture is identified, then it would be mapped to eh corresponding command in step 2718 and the command launched in step 2720.

Users can be able to access settings through motion sensing technology, the mouse, and the keyboard. Customization options can be available in the web-based platforms that can allow a user to make a personal interaction with their computer. In FIG. 28 we can see that the user has many options and can make interaction with their web-based translation platform a breeze.

The systems and methods described herein can also be implemented for mobile operating systems and devices. These systems can be used to improve communications for the deaf by allowing them to have two-way communications by using their natural language. The data is then structured appropriately according to standards of ASL Linguistics to ensure seamless communication.

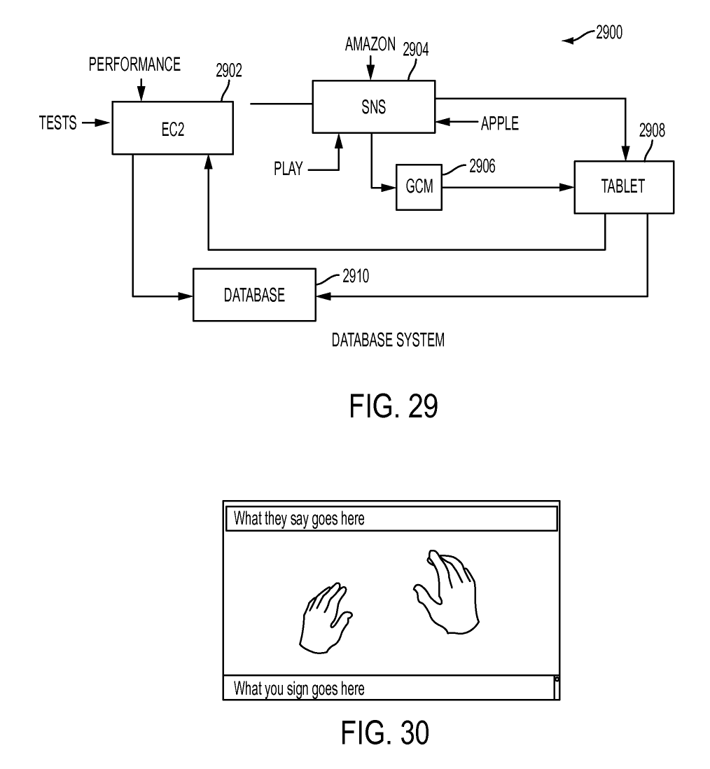

FIG. 29 is a block diagram illustrating a mobile implementation of the systems and methods described herein in accordance with one example embodiment. The above block diagram outlays the overall UNI system 2900. This includes a server 2902 that includes a dictionary database (2910), a tablet (UNI application 2908), Messaging and update service (2904), used by a VP systems, GCM (2906), which can use the google cloud messenger platform.

The dictionary database houses all the signs that the UNI platform uses. This is used for updating the dictionary on the local device or UNI application 2908. This can be used by the crowd sign function.

Server 2902 can process the database 2910 and improve the recognition of the signs.

Messaging and update service 2904 is where the update systems for devices running through the amazon and apple products will receive updates and push notifications for updates, along with the system that will also handle payments for these systems.

GCM 2906 is where the update systems for devices running through google android products will receive updates and push notifications for updates, along with the system that will also handle payments for these systems.

The graphics and interface can be structured in such a way that two-way communication is easily possible. Structured around both the deaf and hearing communication needs, as seen in FIG. 30. The interface can be responsive and can be used in many different operating systems and can allow the user to execute all communication settings changes directly on the device through motion sensing technology. However, there may be some instances where users can access settings through touch screen LCD display as well. Thus, the systems and methods described herein can be implemented in a manner so as to work in conjunction with touch screens.

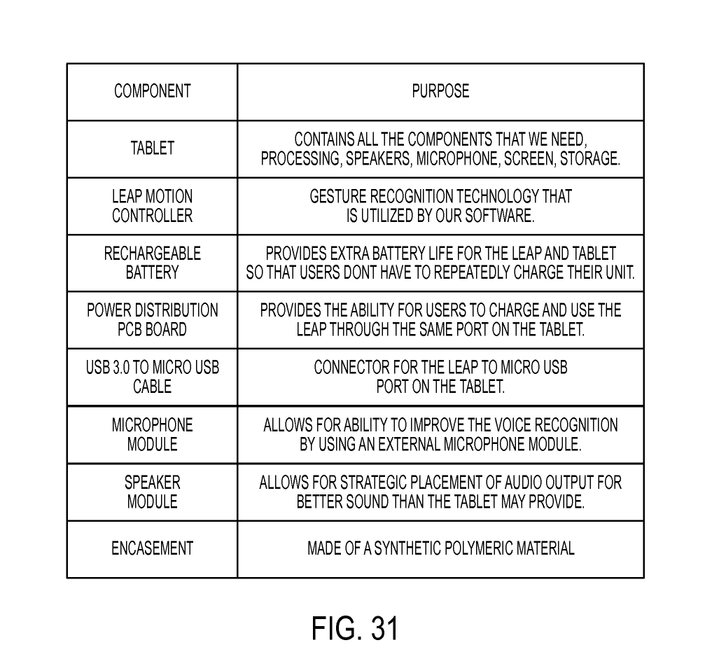

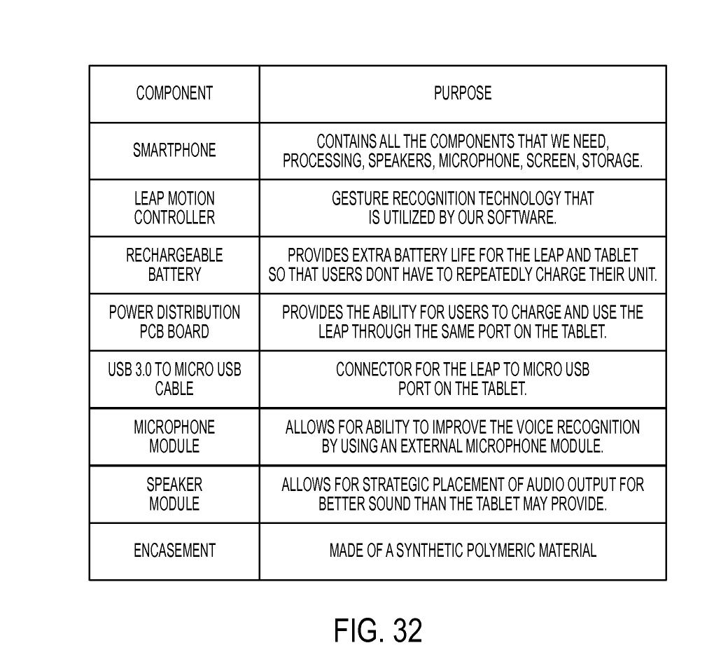

Mobile implementation can be adapted for devices such as smartphones and tablets. It is necessary to make hardware components that allow for system efficiency. There are two categories of systems that can need each need respective hardware components. A list of hardware and materials for use with the Tablet-Style Operating System can be seen in the table of FIG. 31. A list of hardware and materials for use with the Smartphone-Style Operating System can be seen in the table of FIG. 32.

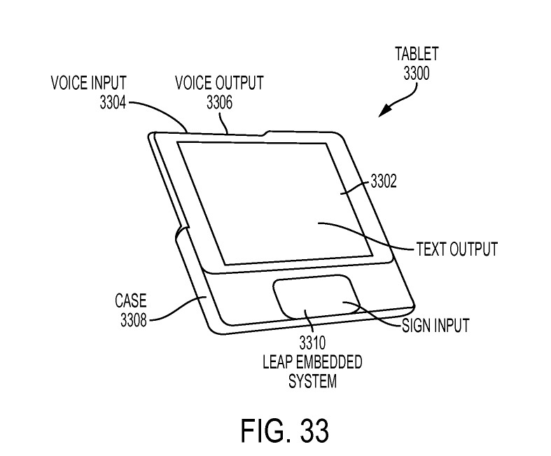

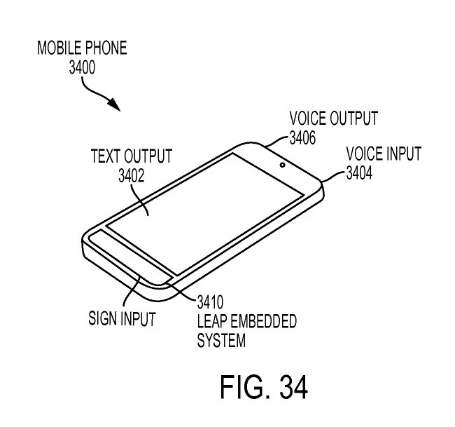

FIGS. 33 and 34 illustrate example implementations for a tablet and smartphone respectively. As can be seen, tablet 3300 can include a microphone 3304 and speaker 3306 for audio communication, a screen 3302 for visual communication such as for text communications, and controller 3310 for implementing the systems and methods described herein. All of the above being within case 3308. Of course, the necessary software, code, applications, etc., would also be loaded into tablet 3300.

Smart phone 3400 can include a microphone 3404 and speaker 3406 for audio communication, a screen 3402 for visual communication such as for text communications, and controller 3410 for implementing the systems and methods described herein. Of course, the necessary software, code, applications, etc., would also be loaded into tablet 3400.

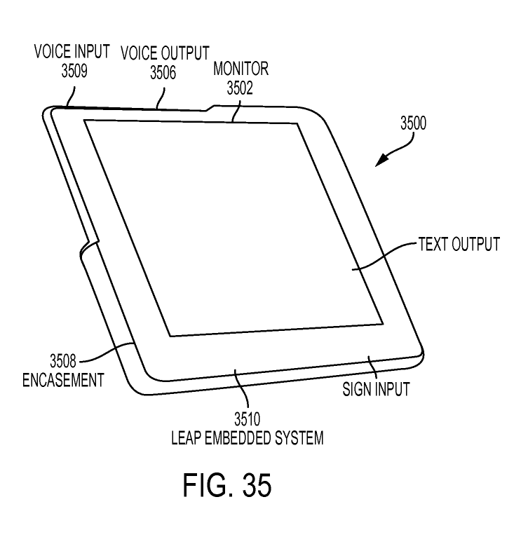

The systems and methods described herein can also be implemented into stand-alone units that can then be used as permanent two-way communication devices in places where services are not already present. The devices can allow users to communicate in either sign language or spoken word. FIG. 35 is a diagram illustrating such a standalone device 3500. As can be seen, device 3500 can include a microphone 3504 and speaker 3506 for audio communication, a screen 3502 for visual communication such as for text communications, and controller 3510 for implementing the systems and methods described herein. All of the above being within case 3508. Of course, the necessary software, code, applications, etc., would also be loaded into tablet 3500.

Conventional video phone systems are used for telecommunications for the deaf/hard-of-hearing. These technologies can be improved by incorporating number and alphabet recognition. Being able to use sign language to navigate contact lists, dial numbers, and spell out short messages, can make communication and system use much more seamless.

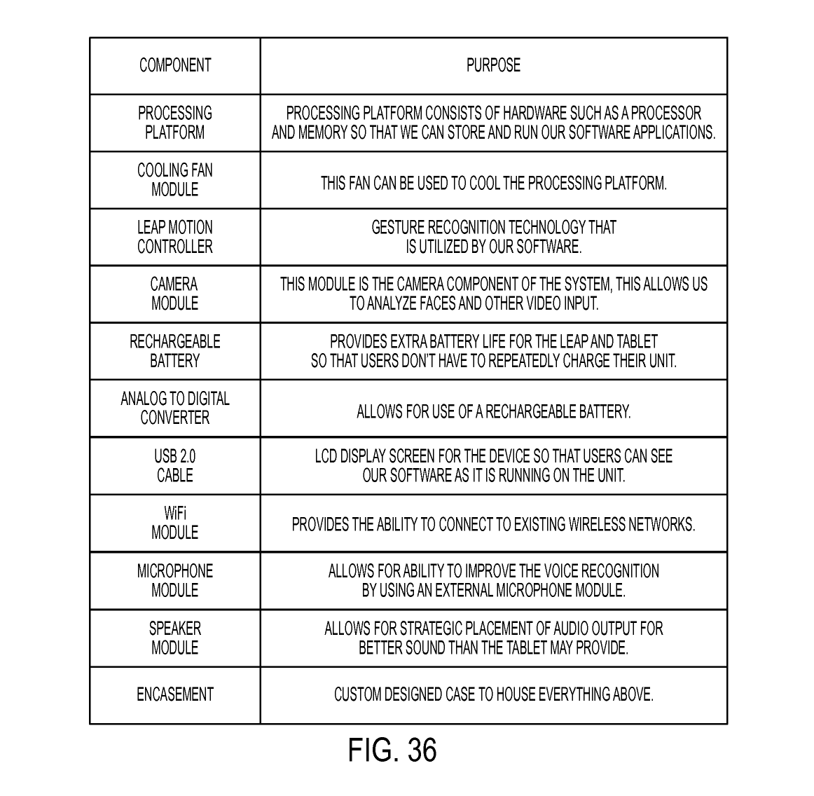

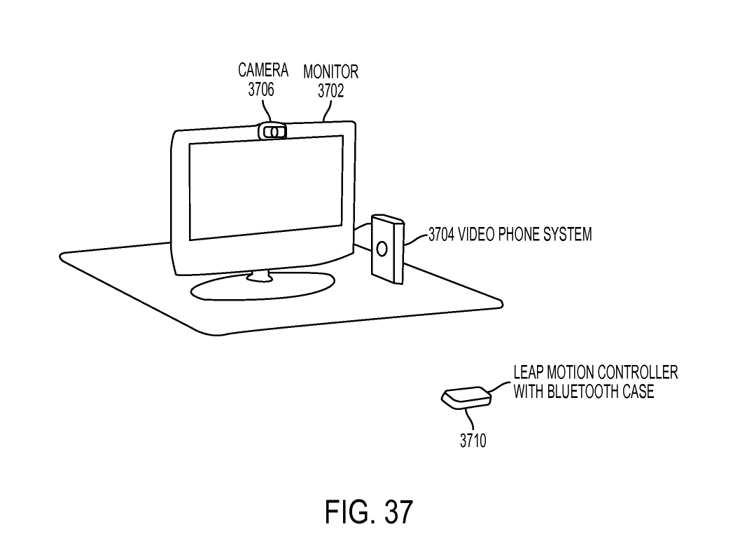

The table of FIG. 36 provides hardware components necessary to implement such a system, while FIG. 37 illustrates and example system. As can be seen, system 3700 can include a monitor 3702 with a camera 3706. The system can also include a video phone sub-system 3704 and a controller 3710.

When using the educational version of the systems and methods described herein, users can need to be immersed in the experience of learning through gesture recognition. Users can be faced with processes that can have two outputs. For example, when using the systems and methods described herein in its educational format, users can be rewarded if the sign is done appropriately in the amount of time given. If the user gets it wrong, then they can be prevented from progressing until the proper signed gesture is made. User can receive updates on progress and rewards for completing successive challenges. The process can be set in gamified design. The data can also be structured appropriately according to standards of ASL Linguistics and education.

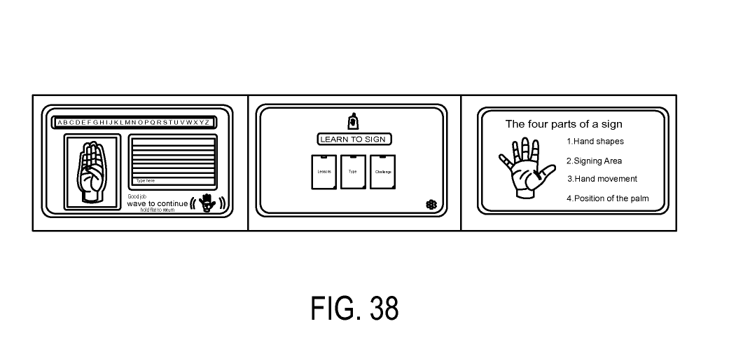

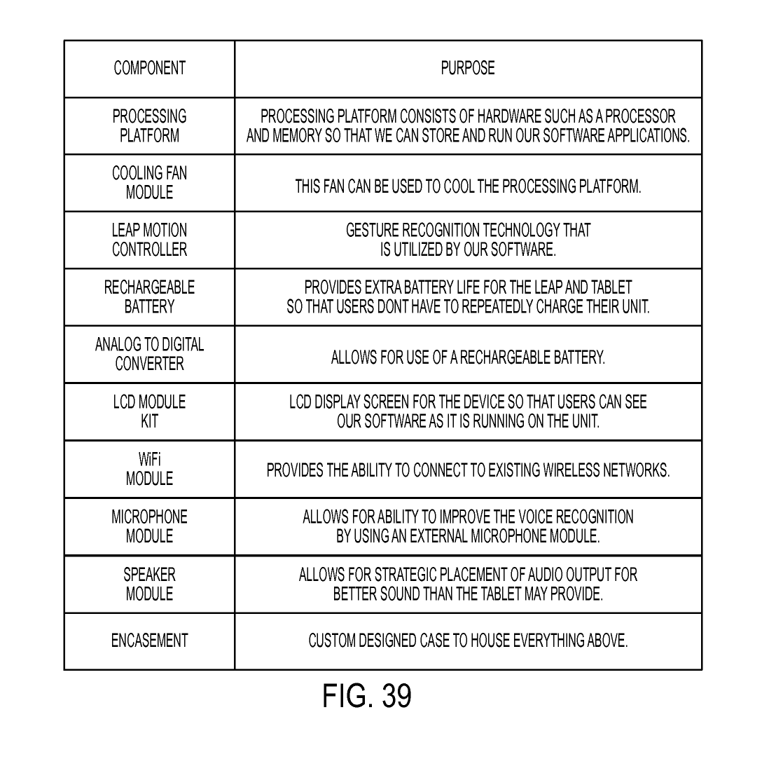

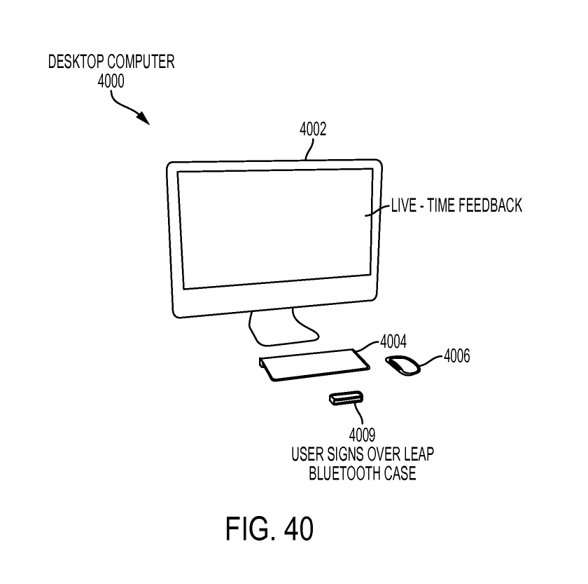

FIG. 38 provides screen shots for common examples of how ASL can be taught using the systems and methods described herein. FIG. 39 provides a table of hardware components that can be used to implement an educational system in accordance with one example embodiment and FIG. 40 is a diagram of an example educational system in accordance with one example embodiment.

It will be understood that in the terms module or engine in the above description refers to the hardware, software and other resources need to carry out or implement the systems and methods described herein some of which are described in more detail below.

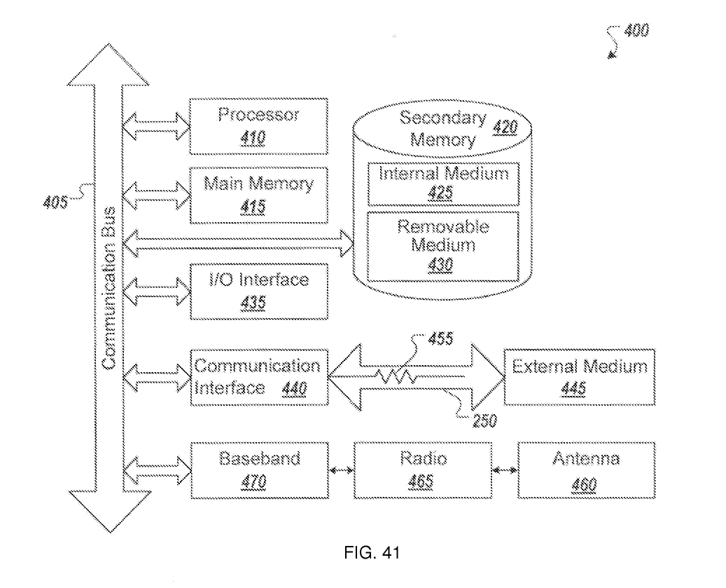

FIG. 41 is a block diagram illustrating an example wired or wireless system 550 that can be used in connection with various embodiments described herein. For example the system 550 can be used as or in conjunction with one or more of the mechanisms or processes described above, and may represent components of device, the corresponding backend server(s), and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Pearl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615 and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A system for recognizing a hand gesture, comprising:
a gesture database configured to store information related to a plurality of gestures;
a recognition controller configured to capture data related to a hand gesture being performed by a user;
a recognition module configured to:
determine hand characteristic information from the captured data,
determine finger characteristic information from the captured data,
compare the hand and finger characteristic information to the information stored in the database to determine a most likely gesture, and
outputting the determined most likely gesture.

2. The system of claim 1, wherein the gesture corresponds to a sign language number.

3. The system of claim 1, wherein the gesture corresponds to a sign language letter.

4. The system of claim 1, wherein the gesture corresponds to a sign language sign.

5. The system of claim 1, wherein the recognition module is configured to determine hand characteristic information by checking the number of hands present in the captured data, checking a palm visible time for each hand present in the captured data, checking the palm position for each visible palm, and checking a palm velocity for each visible palm.

6. The system of claim 1, wherein the recognition module is configured to determine finger characteristics by checking a number of fingers present in the capture data, checking what fingers are present, checking a finger position for fingers that are present, an checking a finger velocity of the fingers that are present.

7. The system of claim 1, wherein the recognition module is further configured to determine classifiers based on the hand and finger characteristic information.

8. The systems of claim 1, wherein the recognition module is further configured to extract features from the hand and finger characteristic information.

9. The system of claim 1, wherein the extracted features include at least one of emotion, movement, orientation, grammar, location and context.

10. A method for recognizing a hand gesture, comprising:
storing information related to a plurality of gestures in a gesture database;
using a recognition controller, capturing data related to a hand gesture being performed by a user;
determining hand characteristic information from the captured data,
determining finger characteristic information from the captured data,
comparing the hand and finger characteristic information to the information stored in the database to determine a most likely gesture, and
outputting the determined most likely gesture.

11. The method of claim 10, wherein the gesture corresponds to a sign language number.

12. The method of claim 10, wherein the gesture corresponds to a sign language letter.

13. The method of claim 10, wherein the gesture corresponds to a sign language sign.

14. The method of claim 10, further comprising determining hand characteristic information by checking the number of hands present in the captured data, checking a palm visible time for each hand present in the captured data, checking the palm position for each visible palm, and checking a palm velocity for each visible palm.

15. The method of claim 10, further comprising determining finger characteristics by checking a number of fingers present in the capture data, checking what fingers are present, checking a finger position for fingers that are present, an checking a finger velocity of the fingers that are present.

16. The method of claim 10, wherein the recognition module is further configured to determine classifiers based on the hand and finger characteristic information.

17. The method of claim 10, wherein the recognition module is further configured to extract features from the hand and finger characteristic information.

18. The method of claim 10, wherein the extracted features include at least one of emotion, movement, orientation, grammar, location and context.

19. A communication device, comprising:
a gesture database configured to store information related to a plurality of gestures;
a recognition controller configured to capture data related to a hand gesture being performed by a user;
a recognition module configured to:
determine hand characteristic information from the captured data,
determine finger characteristic information from the captured data,
compare the hand and finger characteristic information to the information stored in the database to determine a most likely gesture, and
outputting the determined most likely gesture.

20. The device of claim 19, wherein the gesture corresponds to a sign language number.

21. The device of claim 19, wherein the gesture corresponds to a sign language letter.

22. The device of claim 19, wherein the gesture corresponds to a sign language sign.

23. The device of claim 19, wherein the recognition module is configured to determine hand characteristic information by checking the number of hands present in the captured data, checking a palm visible time for each hand present in the captured data, checking the palm position for each visible palm, and checking a palm velocity for each visible palm.

24. The device of claim 19, wherein the recognition module is configured to determine finger characteristics by checking a number of fingers present in the capture data, checking what fingers are present, checking a finger position for fingers that are present, an checking a finger velocity of the fingers that are present.

25. The system of claim 19, wherein the recognition module is further configured to determine classifiers based on the hand and finger characteristic information.

26. The systems of claim 19, wherein the recognition module is further configured to extract features from the hand and finger characteristic information.

27. The system of claim 19, wherein the extracted features include at least one of emotion, movement, orientation, grammar, location and context.
